(19) United States
(12) Patent Application Publication
(10) Pub. No.: US 2025/0024861 A1
(43) Pub. Date: Jan. 23, 2025

(54) PET CHEW AND METHOD FOR PRODUCING A PET CHEW

(71) Applicant: PARAGON PET PRODUCTS EUROPE B.V., Veendam (NL)

(72) Inventors: Felix Johannes Gerhard MÜLLER-OHL, Leer (DE); Sander Hilbert OLDENGARM, Emmen (NL); Gregory George KEAN, Carlisle, MA (US); Janjaap FREIJE, Zuidlaarderveen (NL)

(73) Assignee: PARAGON PET PRODUCTS EUROPE B.V., Veendam (NL)

(21) Appl. No.: 18/696,998

(22) PCT Filed: Sep. 29, 2022
(86) PCT No.: PCT/NL2022/050544

§ 371 Date: Mar. 29, 2024

Related U.S. Application Data
(60) Provisional application No. 63/250,747, filed on Sep. 30, 2021.

(30) Foreign Application Priority Data
Nov. 24, 2021 (EP) 21210209.9

(51) Int. Cl. A23K 40/25; A01K 15/02; A23K 20/163; A23K 50/40

(52) U.S. Cl. CPC A23K 40/25; A23K 20/163; A23K 50/40; A01K 15/026

(57) ABSTRACT

The present invention relates to a pet chew (100), preferably made substantially of a bioplastic material or composition, more preferably a biodegradable and/or edible bioplastic material or composition, yet more preferably a bioplastic material or composition based on starch or so-called thermoplastic starch (TPS) or polymer starch. The pet chew (100), which may be extrusion moulded, comprises at least a first pet chew body (10) and a second pet chew body (20). The first and second pet chew bodies (10, 20) are formed as elongate bodies, preferably substantially stick-shaped bodies. The first and second elongate pet chew bodies (10, 20) extend substantially parallel to each other and are connected to each other at their lateral sides. The pet chew (100) is arranged such that the first pet chew body (10) and the second pet chew body (20) can be torn apart from each other.

### FIELD OF THE INVENTION

The invention relates to pet chews, more particularly biodegradable and/or edible pet chews that can be digestible by a dog or other pet.

### TECHNICAL BACKGROUND

Pet chews are known and are intended to be chewed or gnawed on by animals, in particular dogs. However, pet chews may also be used by other animals or pets, such as for instance rodents, rabbits or birds.

Pet chews are used for different purposes. For example, pet chews may be chewed by pets for health and oral hygiene purposes, such as to help massaging gums, cleaning teeth, or strengthening teeth or jaws. As the pet's brain may release feel-good chemicals as a result of the chewing or gnawing on a pet chew, chewing may also be soothing, for instance in order to ease pain of inflamed gums experienced during teething, or to ease pain due to the setting of roots of teeth.

Although pet chews may thus have advantages, they may also have disadvantages. For example, when the pet chew is edible and also provides nutrition to the pet, the pet may take in too much nutrition in case the pet chew is sized too large for the respective pet. This may for instance occur when a puppy gets a nutritious pet chew intended for a full grown dog and/or when a dog of a relatively small sized breed gets a nutritious pet chew intended for a full grown dog. On the other hand, it can also be disadvantageous when a relatively large dog gets a pet chew which is too small. Although differently sized pet chews are known, it is often not possible for a pet owner to buy a relatively large pet chew having the same smell, taste and/or consistency as a relatively small pet chew to what the pet is used to, for instance already from the moment that the pet was only a very small puppy or other baby pet. For instance due to that, it often happens that a pet gets a wrong size pet chew.

Further, it is noted that pet chews can, additionally or alternatively, be used and/or be intended as a relief from boredom, to satisfy biting instincts and/or to encourage exercise. Pet chews may be used as a toy or play object, and can for instance be thrown away in order to be retrieved by a dog or other pet. It is noted that dogs may enjoy to play with and/or gnaw on stick-shaped, bone-shaped or other elongate objects, such as bones, tree branches or pet chews of a substantially elongate design. Disadvantages of tree branches, bones and such known pet chew may include that these may lead to broken teeth and that these may splinter, which then for instance may cause punctures or other injuries.

For instance for reasons corresponding to the above, there seems to remain a need for an alternative pet chew. It can for instance therefore be an object of the present invention to provide an alternative pet chew. In particular, it can be an object of the invention to provide a pet chew, wherein at least one of the disadvantages of prior art pet chews is counteracted. More in particular, the invention may aim to provide a pet chew which may counteract at least one of the disadvantages above. In embodiments, the invention aims at providing a pet chew which at one hand can be used relatively safely, and which at the other hand can also facilitate using it with differently sized dogs or other pets.

### BRIEF SUMMARY OF THE INVENTION

In embodiments, the present invention is directed to a pet chew, said pet chew comprising at least a first pet chew body and a second pet chew body, wherein the first and second pet chew bodies are formed as elongate bodies, preferably substantially stick-shaped bodies, wherein the first and second elongate pet chew bodies extend substantially parallel to each other and are connected to each other at their lateral sides, preferably wherein the pet chew is made substantially of a bioplastic material or composition, more preferably a biodegradable and/or edible bioplastic material or composition, and wherein the pet chew is arranged such that the first pet chew body and the second pet chew body can be torn apart from each other, in particularly in a manner in which the pet chew will plastically deform prior to failure.

By providing the pet chew, in particular an edible pet chew, with multiple parallelly extending elongate pet chew bodies which can be torn apart in multiple elongate pet chew pieces, the originally purchased pet chew, which may be correctly sized for a relatively large pet, may be torn apart by a person into two or even more relatively small pet chews which apart from each other may be given to a dog or other pet. As a result, a pet owner can easily adapt the size of the pet chew to the pet, for instance considering their age, size or activity level. It may for instance thus be counteracted that a pet receives a too large pet chew, for instance including too much nutrition, or that a grown-up pet, which still longs for the same pet chew it had as a small pet in the past, will for instance will be given undersized pet chews.

By arranging the pet chew such that it can be torn apart, in particular by making it relatively tough or leathery, instead of being brittle, it can be facilitated that one pet chew body can be torn apart from an adjacent pet chew body in a manner which allows for a certain extent of plastic deformation to happen before the connection between said two adjacent pet chew bodies fails. As a result, it can be counteracted that relatively sharp edges form upon separating the pet chew bodies from each other. Hence, it can be counteracted that a dog or other pet may injure itself on a piece taken apart from the initial pet chew.

In a preferred embodiment, at a temperature of 20° C., the pet chew may be relatively tough or leathery, instead of being brittle, thereby allowing that the first pet chew body and the second pet chew body can be torn apart from each other in a manner which allows for plastic deformation before the connection between the first pet chew body and the second pet chew body fails, thereby counteracting the forming of relatively sharp edges. It is noted that in case the pet chew would have been brittle and would have been arranged to be broken apart, which is the case with some known pet chews which can be broken apart into smaller pieces, thus instead of being torn apart as is the case with the present pet chew, the pieces separated by breaking would seem to fit exactly onto each other afterwards, since no plastic deformation would have occurred. However, when the pet chew is relatively tough, as is the case with this present preferred embodiment, the pet chew will plastically deform at the location where the pieces separate from each other, which will be visible by that the pieces will not neatly fit onto each other after being separated. The plastic deformation may thus counteract the forming of relatively sharp edges when the pet owner adjusts the size of the pet chew to their pet, which can counteract that a dog or other pet may injure itself on a piece taken apart from the initial pet chew.

In embodiments, the pet chew may be primarily composed of a bioplastic material or composition based on so-called destructurized starch or destructured starch. This may for instance help support the pet's digestive system.

By arranging the pet chew such that initially laterally attached pet chew bodies can be torn apart along the longitudinal directions of the elongate pet chew bodies, elongate pet chew pieces can be torn off. Such elongate pet chew pieces, which for instance may be substantially stick-shaped, may be relatively well fitted for letting a dog or pet gnaw on them, for instance because such an elongate pet chew piece may to some extent resemble the elongate shape of a bone and/or tree branch.

In embodiments, the pet chew may include a constriction or so-called narrowing between the first pet chew body and the second pet chew body, wherein said constriction or narrowing forms a weakening, wherein said weakening is arranged for allowing the first pet chew body to be torn apart from the second pet chew body.

In preferred embodiments, the pet chew may be formed by means of extrusion moulding. Although an extruder may thus be used to form the pet chew, alternative processes may be used to form the pet chew. For example, the pet chew may be produced using a moulding or a so-called shaping process, such as for instance injection moulding or compression moulding.

The invention also relates to a method for producing a pet chew, wherein the method comprises a step of extrusion moulding a profile product. Said profile product may for instance form the pet chew. Alternatively, the profile product may for instance form a semi-finished product for forming the pet chew. For example, when a so-called continuous profile is being extrusion moulded, the extruded product profile can be cut, or otherwise separated, into pet chews of a certain predetermined length. Additionally, or alternatively, a semi-finished product may be separated into pieces in an other direction, for example by separating pieces along a longitudinal direction of a extruded profile. It will be appreciated that in such embodiments multiple pet chews can be integrally extrusion moulded.

In embodiments, the pet chew, in particular one formed by means of extrusion moulding, may be primarily composed of a material or composition, preferably a bioplastic material or composition, more preferably a bioplastic material or composition based on destructurized potato starch or destructured potato starch, which material or composition, at a pressure of 1 atmosphere, has a freezing point and/or a melting point above 30° C., preferably above 40° C., more preferably above 50° C., yet more preferably above 60° C.

Further advantageous embodiments according to the invention are described in the appended claims.

### DESCRIPTION OF THE DRAWINGS

The foregoing and other objects and features of the present invention may become more fully apparent from the following description and appended claims, in particular when taken in conjunction with the accompanying drawings. Understanding that these drawings depict only non-limiting exemplary embodiments of the present invention, which are not to be considered limiting the scope of the invention, embodiments of the present invention will now be described with reference to the accompanying drawings in which:

FIG. 1 shows a schematic perspective view of a first embodiment of a pet chew according to an aspect of the invention;

FIG. 2 shows a schematic cross-sectional view of the embodiment of the pet chew of FIG. 1.

FIG. 3 shows a schematic cross-sectional view of two pieces of the pet chew of FIGS. 1 and 2 being torn apart; and

FIG. 4 shows a schematic cross-sectional view of a second embodiment of a pet chew according to an aspect of the invention.

### DETAILED DESCRIPTION OF THE INVENTION

It is noted that the figures show merely preferred embodiments according to the invention. In the figures, the same or similar reference signs or numbers refer to equal or corresponding parts.

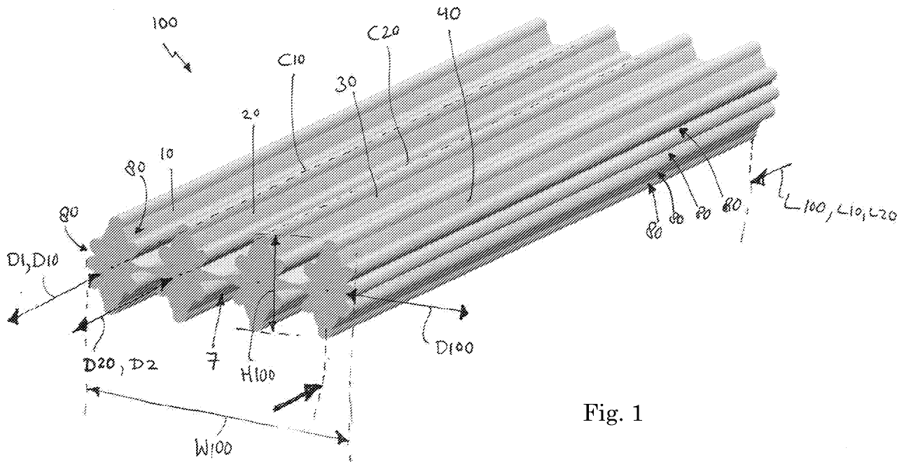

FIG. 1 shows a schematic perspective view of an embodiment of pet chew 100 according to an aspect of the invention.

The pet chew 100 can preferably be made substantially of a bioplastic material or composition, which more preferably may be biodegradable and/or edible, in particular digestible by a respective pet, such as for example a dog. In embodiments, the pet chew may be arranged to provide nutrition to the pet. Advantageously, the bioplastic material or composition can be based on starch or so-called thermoplastic starch (TPS) or polymer starch, in particular so-called destructurized starch or destructured starch, more in particular destructurized potato starch or destructured potato starch.

In preferred embodiments, the pet chew 100 is formed by means of an extrusion moulding process. However, the pet chew 100 can in alternative embodiments be formed by means of any other suitable process, in particular by means of a moulding or a so-called shaping process, such as for instance injection moulding or such as for instance compression moulding.

It is noted that the pet chew 100 comprises at least two pet chew bodies 10, 20, which extend parallel to one other.

Advantageously, as is for instance the case in the here shown extrusion moulded exemplary embodiment of the pet chew 100, a first one 10 of the elongate pet chew bodies may define a first longitudinal direction D10, and said first elongate pet chew body 10 may then have a substantially constant cross-sectional shape and a substantially constant cross-sectional size along said first longitudinal direction D10.

In addition, not only its first pet chew body 10, but the entire pet chew 100 may in embodiments have a substantially constant cross-sectional shape and a substantially constant cross-sectional size along the first longitudinal direction D10.

Although the pet chew 100 of the here shown exemplary embodiment comprises four elongate pet chew bodies 10, 20, 30, 40, the pet chew 100 may comprise another multiple number of pet chew bodies in other embodiment, such as thus for instance two elongate pet chew bodies 10, 20 or such as for instance three, four, five or six elongate pet chew bodies.

Advantageously, the pet chew bodies 10, 20, 30, 40 may be of a substantially stick-shaped design, as can be seen in FIG. 1.

Additionally or alternatively, the exterior of the pet chew body may be provided with at least one groove, and preferably a multiple number of grooves 80, which in particular may extend substantially parallel with the longitudinal direction D1 in which one or multiple pet chew bodies extend. It is noted that such grooves 80 may facilitate a relatively good gnawing experience for the pet. Additionally or alternatively, the grooves 80 may provide for relatively good grip. In particularly in embodiments in which the pet chew is formed by means of an extrusion moulding process, which typically may result in relatively smooth outer surfaces, increased grip provided by the grooves 80 may be advantageously, for instance both for the pet and its owner, or another human user of the pet chew 100.

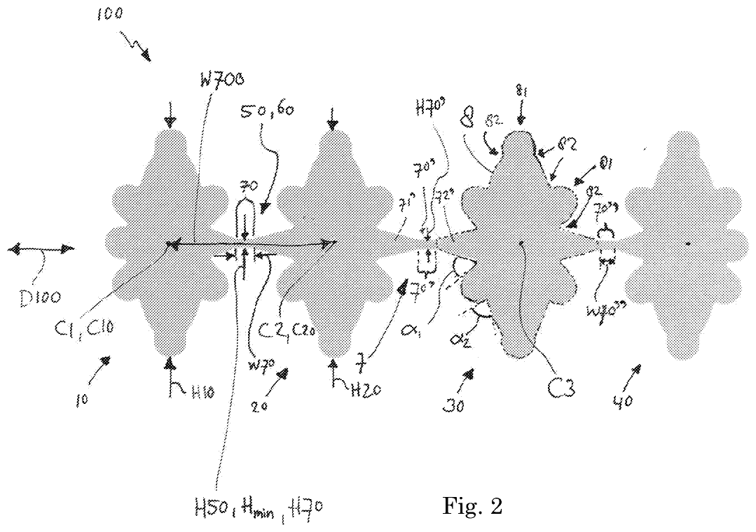

As for instance can be seen in FIG. 2, which shows a cross-sectional view of the pet chew 100 of FIG. 1, the pet chew body 10, 20, 30, 40 may have a cross-section of which the exterior 8 defines multiple protrusions 81 and multiple recesses 82, which recesses may account for the grooves 80. Advantageously, at least some of the exterior angles α₁, α₂ may be smaller than 90°, preferably smaller than 80°, more preferably smaller than 70°. As a result, the grooves 80 may be relatively steep, which may provide for even better grip, in particular to teeth of a dog or other pet.

In embodiments, the cross-section of the pet chew body 10, 20, 30, 40 may be a substantially star-shaped and/or flower-like cross-section, as can be seen relatively well in FIG. 2.

It is noted that each one of the multiple pet chew bodies 10, 20, 30, 40 may preferably have substantially the same cross-sectional size, and more preferably also substantially the same cross-sectional shape, as is the case in the exemplary embodiments shown in the figures. However, in alternative embodiments, different ones of the pet chew bodies of a single pet chew 100 may have substantially different sizes and/or substantially different shapes.

As can be seen in the figures, at least a first one and a second one of the parallelly extending elongate pet chew bodies 10, 20 are connected to each other at their lateral sides, for example by means of a flange and/or a bridging part 7 extending from the first pet chew body 10 towards the second pet chew body 20, as for example can be seen in FIG. 2. A further elongate pet chew body 30, if any, may be connected to the second pet chew body 20, for instance at a second lateral side of said second pet chew body 20, opposite to the first lateral side at which the first pet chew body 10 is connected to said second pet chew body 20.

Preferably, the one or multiple flanges and/or a bridging parts 7 interconnecting adjacent pet chew bodies may preferably extend substantially radially away with respect to the centre C1, C2, C3, C4 of the respective pet chew body 10, 20, 30, 40.

Although bridging parts 7 may advantageously be provided between adjacent pet chew bodies, in alternative embodiments, such as for instance in the one shown in FIG. 4, adjacent pet chew bodies 10, 20, 30, 40 may directly abut each other.

Advantageously, two adjacent ones of the multiple pet chew bodies may thus be connected to each other, preferably at their respective lateral sides. Like the connection between the first and the second pet chew bodies 10, 20, also such other connections may be in a manner allowing that one of said two adjacent pet chew bodies can be ripped off from the other one.

In the here shown exemplary embodiments, the pet chew 100 is of a substantially mat-shaped design, in particular one which is relatively flat. This is, the multiple pet chew bodies extend substantially parallel to each other and each further pet chew body is offset with respect to the previous one in substantially the same direction in which the second pet chew body 20 is offset with respect to the first pet chew body 10. The pet chew 100 may thus form a sheet-shaped or mat-shaped object, which may be embossed, as can be seen in FIG. 1. The embossment may for instance be due to grooves 80 in the pet chew bodies and/or due to constrictions 50 or so-called narrowings 50 between adjacent pet chew bodies, which constrictions or narrowings 50 may provide for local weakenings enabling that the pet chew bodies may be ripped apart.

In embodiments, the pet chew 100 may be of an elongate design. This is, seen from above or from below, in particular when seen in a direction substantially transverse to the longitudinal directions D1, D2 of the pet chew bodies and substantially transverse to the direction in which the first pet chew body is offset from the second pet chew body, the length L100 of the pet chew 100, measured in the longitudinal directions D1, D2 of the pet chew bodies, may be substantially larger than the width W100 of the pet chew 100. Preferably, the length L100 of the pet chew 100 may be at least 125%, preferably at least 150%, of the width W100 of the pet chew 100.

In addition, or alternatively, the width W100 of the pet chew 100 may be substantially larger than the height H100 of the pet chew 100. For example said with W100 may be at least 150% of said height H100, preferably more than 200% of said height H100.

Advantageously, the pet chew 100 may thus be arranged such that it has a substantially elongate design, even without tearing off any piece thereof.

In addition, or alternatively, the elongate pet chew bodies may be relatively long, for instance having a length L10, L20 being at least three times, preferably at least four times or even at least five time times, bigger than the largest cross-sectional dimension of the pet chew body, which largest cross-sectional dimension may for instance be formed by the height H10, H20 of the pet chew body 10, 20, 30, 40 or the by the width of the pet chew body 10, 20, 30, 40. By arranging the pet chew such that initially laterally attached pet chew bodies 10, 20, 30, 40 which can be ripped off along the longitudinal directions D10, D20 of the elongate pet chew bodies, elongate pet chew pieces 101, 102 can be ripped apart. Such elongate pet chew pieces 101, 102 may for instance be substantially stick-shaped, in particular when they comprise a single pet chew body 10, or may for instance be substantially form a sheet-shaped or mat-shaped object, which may be embossed, in particular when such piece still comprises multiple pet chew bodies.

According to an aspect of the present invention, the pet chew 100 is thus arranged such that one or multiple pet chew bodies can be torn off from one or multiple other pet chew bodies. Thereto, the pet chew 100 may include a respective constriction 50 or so-called narrowing 50 between two adjacent pet chew bodies, which constriction or narrowing forms a weakening, and wherein said weakening may then allow that respective pet chew bodies can be torn off from each other. Advantageous, the constriction 50 or so-called narrowing 50 may have a maximum height H50 which is less than 20%, preferably at most 15%, more preferably at most 10%, yet more preferably at most 5% of the maximum height H10, H20 of the two adjacent pet chew bodies, or even of the maximum height H100 of the entire pet chew 100.

In embodiments, the pet chew 100 can thus include a bridging part 7, wherein said bridging part 7 is connecting a respective pet chew body 10 with an adjacent pet chew body 20. For instance in such embodiments, a first one 20 of the pet chew bodies may then be provided with a first protrusion 71′, said first protrusion 71′ extending away in a direction towards a second one 30 of the pet chew bodies, wherein said first protrusion 71′ is connected to said second one 30 of the pet chew bodies. Preferably, said second one 30 of the pet chew bodies 30 may then be provided with a second protrusion 72′ extending away in a direction towards the first one 20 of said pet chew bodies, wherein the first protrusion 71′ may then be connected to the second protrusion 72′, as for instance can be seen in FIG. 2.

Additionally or alternatively, in a cross-section substantially transverse to the longitudinal directions D10, D20 in which the first and second elongate pet chew bodies 10, 20 extend, the bridging part 60 can taper from the first pet chew body 10 towards the constriction or narrowing 50, which may be included in the bridging part 60 between two adjacent pet chew bodies. Preferably, in said cross-section substantially transverse to the longitudinal directions D10, D20 in which the first and second elongate pet chew bodies 10, 20 extend, the bridging part 60 may then also taper from the second pet chew body 20 towards said constriction or narrowing 50.

For example, the two tapering parts 71′, 72′ may directly contact each other, or alternatively an intermediate portion 70′ may be provided between said two tapering parts 71′, 72′. Preferably, said intermediate portion 70′ may define the smallest height H70′, Hₘᵢₙ of any location between the two centres C2, C3 of the two respective adjacent pet chew bodies 20, 30.

Advantageous, the cross-section of the pet chew 100 can have a smallest height Hₘᵢₙ, said smallest height Hₘᵢₙ being defined as the lowest height of all locations between the centres of two adjacent pet chew bodies, wherein, along the width direction D100 of the pet chew 100, over at least 65%, preferably at least 75%, more preferably at least 85%, of the width W700 extending between the two adjacent centre lines C10, C20, the cross-section of the pet chew 100 has a height being larger than the smallest height Hₘᵢₙ.

In embodiments, the ratio of the width W70, W70″ of the intermediate portion 70, 70′, 70″ and the width W700 extending between the two adjacent centre lines C10, C20 may be at most ¼, preferably at most ⅕, more preferably at most ⅙, yet more preferably at most 1/7, such as for instance about ⅛ or about 1/10.

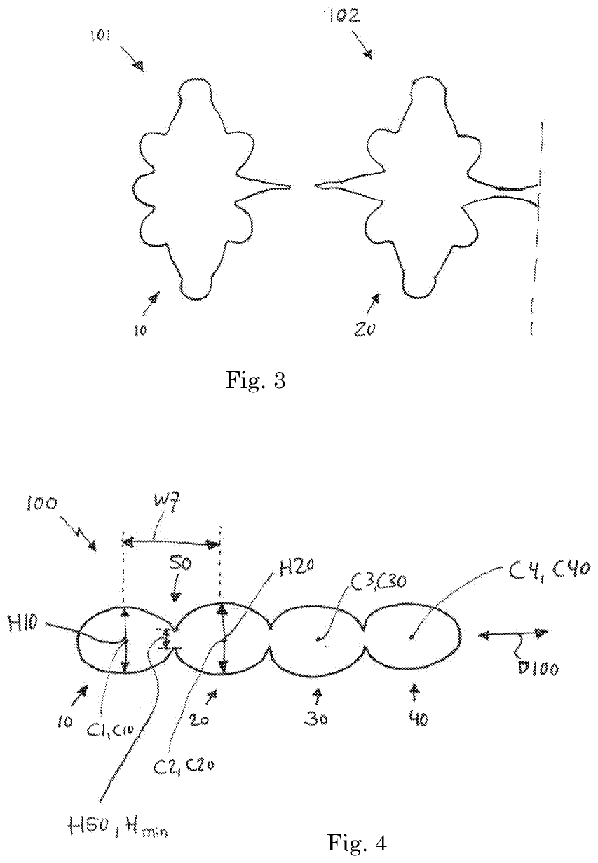

By providing a relatively thin connection between two adjacent elongate pet chew bodies, in particular in combination with a relatively tough or leathery material, it can be facilitated that the pet chew may be ripped apart in a manner substantially lacking burrs and wire edges and the like. In particular, the pet chew is arranged such that its respective pet chew bodies can be torn apart from each other, in particularly in a manner in which the pet chew will plastically deform prior to failure, which may result in a ductile tear or ductile rip, as is depicted in FIG. 3 which shows that one piece 101, substantially consisting of one pet chew body 10, is torn off from the rest 102 of the initial pet chew 100.

As mentioned before, the pet chew 100 may preferably be produced by means of an extruder. The method of producing the pet chew 100 may include a step of extrusion moulding a profile product. In particular, a melted bioplastic material or composition can be forced through a die in order to form the profile product, and the profile product can subsequently be hardened by allowing it to cool.

The material or composition used for the extrusion moulding process may be a bioplastic material or composition, which, at a pressure of 1 atmosphere, may preferably has a melting point and/or a freezing point above 30° C., preferably above 40° C., more preferably above 50° C., yet more preferably above 60° C. Hence, it can be enabled that the pet chew 100, or ripped-off pieces 101, 102, may be solid to at least a certain extent at normal operating temperatures of the pet chew 100 or piece 101, 102 thereof.

The extrusion moulded profile product may directly form the pet chew 100. However, in preferred embodiments, the extrusion moulding may be a substantially continuous process, and the profile product may then form a semi-finished product for forming the actual pet chew 100. The semi-finished product can be separated, for instance cut, into pet chews 100 of a certain predetermined length.

The die used during the extrusion moulding may be a die of a cross-section corresponding with a single pet chew 100 to be formed. However, in alternative embodiments, the die may be of a cross-section corresponding with the cross-section of multiple pet chews to be formed. For example, multiple initially laterally interconnected pet chews.

It is noted that for the purpose of clarity and a concise description features are described herein as part of the same or separate embodiments, however, it will be appreciated that the scope of the invention may include embodiments having combinations of all or some of the features described.

Further, it is noted that the invention is not restricted to the embodiments described herein. It will be understood that many variants are possible.

For example, although the pet chews according to the exemplary embodiments shown in the figures all have a solid shape, the pet chew may in alternative embodiments have one or more hollow cavities, which may for instance form hollow cores of the pet chew bodies. Such hollow cavities may for instance be formed within the extruded material by means of one or more suspended centre pieces provided at the die.

Such and other variants will be apparent for the person skilled in the art and are considered to lie within the scope of the invention as formulated in the following claims.

1. A pet chew, comprising at least a first pet chew body and a second pet chew body,
wherein the first pet chew body and the second pet chew body are elongate bodies,
wherein the first pet chew body and the second pet chew body extend substantially parallel to each other and are connected to each other at their lateral sides,
and
wherein the pet chew is configured such that the first pet chew body and the second pet chew body can be torn apart from each other.

2. The pet chew according to claim 1,
wherein the pet chew is formed by moulding.

3. The pet chew according to claim 1,
wherein the pet chew is formed by means of extrusion moulding; and/or
wherein the pet chew is comprised substantially of a material or com-position, which, at a pressure of 1 atmosphere, has a freezing point above 30° C.

4. The pet chew according to claim 1, wherein the pet chew is comprised substantially of a material or composition, which, at a pressure of 1 atmosphere, has a melting point above 30° C.

5. The pet chew according to claim 1,
wherein the first pet chew body comprises a first longitudinal direction, and wherein the first pet chew body has a substantially constant cross-sectional shape and a substantially constant cross-sectional size along the first longitudinal direction.

6. The pet chew according to claim 1,
wherein the second pet chew body comprises a second longitudinal direction, and wherein the second pet chew body has a substantially constant cross-sectional shape and a substantially constant cross-sectional size along the second longitudinal direction; and/or
wherein the pet chew includes a constriction between the first pet chew body and the second pet chew body, the constriction configured to allow the first pet chew body to be torn apart from the second pet chew body.

7. The pet chew according to claim 1, wherein the pet chew includes a bridging part, the bridging part connecting the first pet chew body (10) with the second pet chew body.

8. The pet chew according to claim 1,
wherein the pet chew body comprises a width direction which extends in the direction in which a center line of the first pet chew body is offset from a center line of the second pet chew body,
wherein the first pet chew body has a first height which is to be measured in a direction substantially transverse to the width direction of the pet chew and substantially transverse to the first longitudinal direction in which the center line of the first pet chew body extends,
wherein the second pet chew body has a second height which is to be measured in a direction substantially transverse to the width direction of the pet chew and substantially transverse to the second longitudinal direction in which the center line of the second pet chew body extends,
wherein, along the width of the pet chew, at a location between the center of the first pet chew body and the center of the second pet chew body, the pet chew comprises an intermediate height,
wherein the intermediate height is smaller than the first height and smaller than the second height.

9. The pet chew according to claim 1,
wherein a cross-section of the pet chew has a smallest height (Hₘᵢₙ), the smallest height (Hₘᵢₙ) being the lowest height of all locations between the center of the first pet chew body and the center of the second pet chew body,
wherein the pet chew comprises a width direction which extends in the direction in which a center line of the first elongate pet chew body is offset from a center line of the second pet chew body,
wherein, along the width direction of the pet chew, over at least 65% of the width extending between the center line of the first pet chew body and the center line of the second pet chew body, the cross-section of the pet chew has a height larger than the smallest height (Hₘᵢₙ).

10. The pet chew according to claim 1, wherein the pet chew, at a temperature of 20° C., the first pet chew body and the second pet chew body are configured to be torn apart from each other in a manner which allows for plastic deformation before the connection between the first pet chew body and the second pet chew body fails.

11. The pet chew according to claim 1,
wherein the pet chew comprises more than two elongate pet chew bodies,
wherein the pet chew bodies extend substantially parallel to each other.

12. The pet chew according to claim 1, wherein at least the first pet chew body, has a substantially star-shaped cross-section or a substantially flower-like cross-section.

13. A method for producing a pet chew according to claim 1, the method comprising:
a step of extrusion moulding a profile product, the profile product forming the pet chew or a semi-finished product for forming the pet chew, using a die of a cross-section corresponding with one or multiple pet chews to be formed.

14. The method according to claim 13,
wherein the extruded profile product is separated into pet chews of a certain predetermined length; and/or
wherein a melted bioplastic material or composition is forced through a die in order to form the profile product, wherein the profile product is subsequently hardened by allowing it to cool.

15. (canceled)

16. The pet chew according to claim 1, wherein the pet chew is comprised substantially of a bioplastic material or composition.

17. The pet chew according to claim 1, wherein the pet chew is comprised of a biodegradable and/or edible bioplastic material or composition.

18. The pet chew according to claim 1, wherein the pet chew comprises starch, thermoplastic starch (TPS) and/or polymer starch.

19. The pet chew according to claim 1, wherein the pet chew comprises destructurized starch and/or destructured starch.

20. The pet chew according to claim 19, wherein the pet chew comprises destructurized potato starch and/or destructured potato starch.

21. The pet chew according to claim 7, wherein the pet chew includes a constriction between the first pet chew body and the second pet chew body wherein, in a cross-section substantially transverse to a longitudinal direction in which the first pet chew body and the second pet chew body extend, the bridging part tapers from at least one of the first pet chew body and the second pet chew body, towards the constriction.

22. The pet chew according to claim 9, wherein along the width extending between the center line of the first pet chew body and the center line of the second pet chew body (20), only a single portion of a cross-section of the pet chew has a height corresponding with the smallest height (Hₘᵢₙ).
